(19) United States
(12) Patent Application Publication
(10) Pub. No.: US 2024/0330186 A1
(43) Pub. Date: Oct. 3, 2024

(54) Cache Directory Lookup Address Augmentation

(71) Applicant: Advanced Micro Devices, Inc., Santa Clara, CA (US)

(72) Inventors: Travis Henry Boraten, Austin, TX (US); Varun Agrawal, Westford, MA (US)

(73) Assignee: Advanced Micro Devices, Inc., Santa Clara, CA (US)

(21) Appl. No.: 18/192,925

(22) Filed: Mar. 30, 2023

(51) Int. Cl. G06F 12/0817

(52) U.S. Cl. CPC G06F 12/0817

(57) ABSTRACT

Cache directory lookup address augmentation techniques are described. In one example, a system includes a cache system including a plurality of cache levels and a cache coherence controller. The cache coherence controller is configured to perform a cache directory lookup using a cache directory. The cache directory lookup is configured to indicate whether data associated with a memory address specified by a memory request is valid in memory. The cache directory lookup is augmented to include an additional memory address based on the memory address.

### BACKGROUND

Processing-in-memory (PIM) architectures move processing of memory-intensive computations to memory. This contrasts with standard computer architectures which communicate data back and forth between a memory and a remote processing unit. In terms of data communication pathways, remote processing units of conventional computer architectures are further away from memory than processing-in-memory components.

As a result, these conventional computer architectures suffer from increased data transfer latency, which can decrease overall computer performance and increase energy cost. Further, due to the proximity to memory, PIM architectures can also provision higher memory bandwidth and reduced memory access energy relative to conventional computer architectures particularly when the volume of data transferred between the memory and the remote processing unit is large. Thus, processing-in-memory architectures enable increased energy efficiency (e.g., performance per Joule) while reducing data transfer latency as compared to conventional computer architectures that implement remote processing hardware.

### BRIEF DESCRIPTION OF THE DRAWINGS

FIG. 1 is a block diagram of a non-limiting example system having a device that implements a processing unit and memory module to implement cache directory lookup address augmentation techniques based on a cache directory lookup.

FIG. 2 is a block diagram of a non-limiting example system showing operation of a cache coherence controller of FIG. 1 in greater detail as performing a cache directory lookup and generation of a cache request based on the cache directory lookup.

FIG. 3 is a block diagram of a non-limiting example system illustrated using first, second, and third stages as showing receipt of a memory request specifying a memory address, generation of an additional memory address based on the memory address, and performance of a cache directory lookup using the memory address and the additional memory address.

FIG. 4 is a block diagram of a non-limiting example system illustrated using first, second, and third stages as showing validation of data in the memory through use of a cache request and a cache response and forwarding of a memory request to initiate performance of a processing-in-memory operation.

FIG. 5 is a block diagram of a non-limiting example system illustrated using first, second, and third stages as showing receipt of a subsequent memory request specifying an additional memory address, performance of a cache directory lookup using the additional memory address, and transmitting the subsequent memory request based on a determination that the additional memory address is valid in the memory.

FIG. 6 a block diagram of a non-limiting example procedure describing performance of an augmented cache directory lookup.

FIG. 7 a block diagram of a non-limiting example procedure describing performance of a cache directory lookup for an augmented additional memory address of FIG. 6.

### DETAILED DESCRIPTION

### Overview

Processing-in-memory (PIM) incorporates processing capability within memory modules so that tasks are processed directly within the memory modules. Processing-in-memory (PIM) techniques also refer to incorporation of processing capability near memory modules so that tasks are also processed without costly round-trip transmission to host processors or other distant computing units. To do so, processing-in-memory leverages techniques are configurable to trigger local computations at multiple memory modules in parallel without involving data movement across a memory module interface, which improves performance, especially for data-intensive workloads such as machine learning.

One of the technical problems of offloading computations to memory (e.g., using PIM techniques) is to ensure that data that is a subject of a memory request is valid in memory, e.g., for use as part of a processing-in-memory operation. A device, for instance, is configurable to include a plurality of cores and associated cache systems as well as memory included in the memory modules, e.g., as dynamic random access memory (DRAM).

In order to ensure data validity such that a processing-in-memory operation is performed using “valid” data, a cache coherence controller implements cache directory lookups to query a cache directory. The cache directory maintains cache directory entries that reference memory addresses maintained in respective cache levels of the cache system, e.g., a location of a respective memory address and a status of the respective memory address. The cache directory entries also reference whether data at those memory addresses is “clean” or “dirty” as being unchanged or changed with respect to versions of that data maintained in memory. In other words, the cache directory lookup indicates whether data maintained in the memory has a corresponding version in the cache system and whether that version is changed in the cache system with respect to the memory.

If the data in the memory is not valid in memory for execution of a processing-in-memory instruction (meaning that the data in the cache system is more recent) the cache coherence controller transmits a cache request to the cache system. This causes the cache system to transmit a cache response to the memory such that the data in the memory is subsequently valid for computation by the processing-in-memory component. This is performable, for instance, by leveraging the cache request to cause the cache system to write the data back to memory (e.g., “flush” the data) and/or invalidate the data in the cache system. The cache coherence controller then releases the memory request to the processing-in-memory component for processing, e.g., via a memory controller for performance as part of a processing-in-memory operation.

For example, if a cache system stores “dirty” data for a memory address associated with a memory request, the dirty data is first flushed from the cache system to memory to ensure that the memory request and corresponding processing-in-memory operation is performed using a most recent version of the data. If the cache system stores clean data for the memory request, the clean data is invalidated at the cache system, e.g., through another cache request. This is performed by the cache coherence controller to ensure that subsequent memory requests retrieve the data from memory instead of using stale data from the cache system. This “round trip” in each instance involving the cache coherence controller, the cache system, and memory causes memory requests in conventional techniques to stall at the probe filter while waiting for the cached data to be evicted and written back as part of a cache response to memory or invalidated. This results in computational inefficiencies, increased power consumption, and delays.

To overcome these challenges, cache directory lookup address augmentation techniques are described. The techniques are configurable to leverage configuration of processing-in-memory operations to improve cache directory lookup efficiency as well as cache access efficiency. These techniques are configured to leverage insight that a series of memory requests are likely to involve neighboring memory addresses in the memory.

Accordingly, a cache directory lookup is performed for a memory address in a memory request and is augmented to include an additional memory address, e.g., a neighboring memory address, that is selected based on the memory address. As a result, data at the additional address is made valid, if not already, before receiving a memory request to access the data at the additional address. This reduces latency resulting from a round trip communication with the cache system in order to validate data included in the memory for the additional memory address that otherwise might be invalid. For example, the data in the memory for the additional memory address, if determined as not valid as part of the cache directory lookup, is made valid in memory by “flushing” the data from the cache system or invalidating the data at the cache system. As a result, the data in the memory for the additional address is valid ahead of time for a subsequent memory access and processing-in-memory operation.

A single processing-in-memory operation, for instance, is configurable to execute a same operation (i.e., instruction) at a row and column specified in a memory request for each of a plurality of memory banks in memory. To reduce an overhead of opening new rows in memory, processing-in-memory operations are configurable to leverage spatial locality and issue a subsequent memory request to the same rows. Techniques used to perform memory address interleaving, for instance, are usable to place multiple blocks of adjacent data in a same row in memory. Typically, processing-in-memory operations are employed in real-world scenarios for large data structures that cover entire rows in the memory banks, and potentially several rows. Therefore, if a processing-in-memory operation operates using a particular row and column in a memory bank, a subsequent processing-in-memory operation is likely to involve access to other columns in the same row activations.

Cache directory lookups are used in the techniques described herein to augment memory addresses utilized as part of a cache directory lookup, e.g., for other columns in a row to reduce cache directory lookup latency when subsequent memory requests are received. The cache coherence controller, for instance, is configurable to leverage memory request patterns exhibited as part of processing-in-memory operations by speculatively performing cache directory lookups for an additional memory address, e.g., that is not included in the memory request. In one example, the cache request augmentation controller is configurable to identify the additional memory address based on a memory address included in the memory request. This is performable with the expectation that a subsequent memory request will likely arrive for that additional memory address, e.g., based on temporal locality and/or spatial locality.

In an example of spatial locality, the cache request augmentation controller augments the cache directory lookup for each of the columns within a row for each of the memory banks associated with a memory address in the memory request. Therefore, subsequent memory requests that involve that additional memory address (e.g., for the other columns within the row) are performable as a single cache directory lookup as being “valid” without encountering the lag and delay involved with the “round trip” of conventional techniques. As a result, a subsequent memory request (e.g., and associated PIM operations) in the same row are not stalled, e.g., by waiting for the cache system to return evicted data to memory and/or to acknowledge invalidation of the data in the cache system. In this way, the techniques described herein improve operational efficiency, reduce latency, and reduce power consumption. Further discussion of these and other examples is included in the following sections and shown in corresponding figures.

In some aspects, the techniques described herein relate to a system including a cache system including a plurality of cache levels, and a cache coherence controller configured to perform a cache directory lookup using a cache directory, the cache directory lookup configured to indicate whether data associated with a memory address specified by a memory request is valid in memory, the cache directory lookup augmented to include an additional memory address based on the memory address.

In some aspects, the techniques described herein relate to a system, wherein the cache directory lookup is configured to indicate whether the data associated with the memory address specified by the memory request is valid in memory for use as part of a processing-in-memory operation by a processing-in-memory component.

In some aspects, the techniques described herein relate to a system, wherein the cache directory lookup is configured to indicate whether data associated with the additional memory address is valid in memory for use as part of a processing-in-memory operation by a processing-in-memory component.

In some aspects, the techniques described herein relate to a system, wherein the cache directory includes a plurality of cache directory entries that indicate memory addresses are maintained in the cache system.

In some aspects, the techniques described herein relate to a system, wherein the plurality of cache directory entries specify, respectively, a location of respective memory addresses in the plurality of cache levels in the cache system and a status of the respective memory addresses.

In some aspects, the techniques described herein relate to a system, wherein the cache coherence controller is configured to transmit a cache request to the cache system based on the cache directory lookup indicating the data associated with the memory address specified by the memory request is not valid in the memory for use as part of a processing-in-memory operation by a processing-in-memory component.

In some aspects, the techniques described herein relate to a system, wherein the cache request is configured to cause the cache system to invalidate the data associated with the memory address in the cache system.

In some aspects, the techniques described herein relate to a system, wherein the cache request is configured to cause the cache system to transmit a cache response to the memory, the cache response configured to cause data stored at the memory address in the memory to be valid for use as part of the processing-in-memory operation by the processing-in-memory component.

In some aspects, the techniques described herein relate to a system, wherein the cache response is further configured to cause data stored at the additional memory address in the memory to be valid.

In some aspects, the techniques described herein relate to a system, wherein the cache coherence controller is configured to transmit a cache request to the cache system based on the cache directory lookup indicating the data associated with the additional memory address specified by the memory request is not valid

In some aspects, the techniques described herein relate to a system, wherein the cache coherence controller is further configured to transmit the memory request for receipt by the memory subsequent to receipt of a cache response from the cache system.

In some aspects, the techniques described herein relate to a system, wherein the memory request is configured to cause a processing-in-memory component of the memory to process data stored at the memory address in the memory.

In some aspects, the techniques described herein relate to a system, wherein the cache coherence controller is configured to select the additional address based on spatial locality.

In some aspects, the techniques described herein relate to a system, wherein the memory request is received from a core of a processing unit.

In some aspects, the techniques described herein relate to a device including a cache system including a plurality of cache levels, a memory module having a memory and a processing-in-memory component, and a cache coherence controller configured to transmit a cache request to the cache system based on a cache directory lookup performed in response to a memory request, the cache request configured to cause the cache system to transmit a cache response to the memory module, the cache response including data from the cache system for a memory address of the memory request and augmented by data from an additional memory address selected by the cache coherence controller as part of the cache directory lookup.

In some aspects, the techniques described herein relate to a device, wherein the cache directory lookup is performed using a cache directory having a plurality of cache directory entries that define which memory addresses are maintained in the cache system.

In some aspects, the techniques described herein relate to a device, wherein the cache response is configured to cause data stored at the memory address and the additional memory address in the memory to be valid.

In some aspects, the techniques described herein relate to a device, wherein the memory request is configured to cause the processing-in-memory component to process the data stored at the memory address in the memory.

In some aspects, the techniques described herein relate to a method including performing a cache directory lookup in a cache directory of a cache coherence controller to indicate whether data at a memory address specified in a memory request as part of a processing-in-memory instruction is valid in memory, and whether an additional memory address is valid in the memory, the additional memory address selected by the cache coherence controller based on the memory address specified in the processing-in-memory instruction, transmitting a cache request by the cache coherence controller for receipt by a cache system, the cache request configured to cause the cache system to transmit a cache response to cause the data at the memory address or the additional memory address in the memory to be valid, and transmitting the memory request by the cache coherence controller for receipt by a memory module that includes the memory.

In some aspects, the techniques described herein relate to a method, wherein transmitting the memory request by the cache coherence controller for receipt by a memory module that includes the memory is configured to cause execution of the processing-in-memory instruction by a processing-in-memory component.

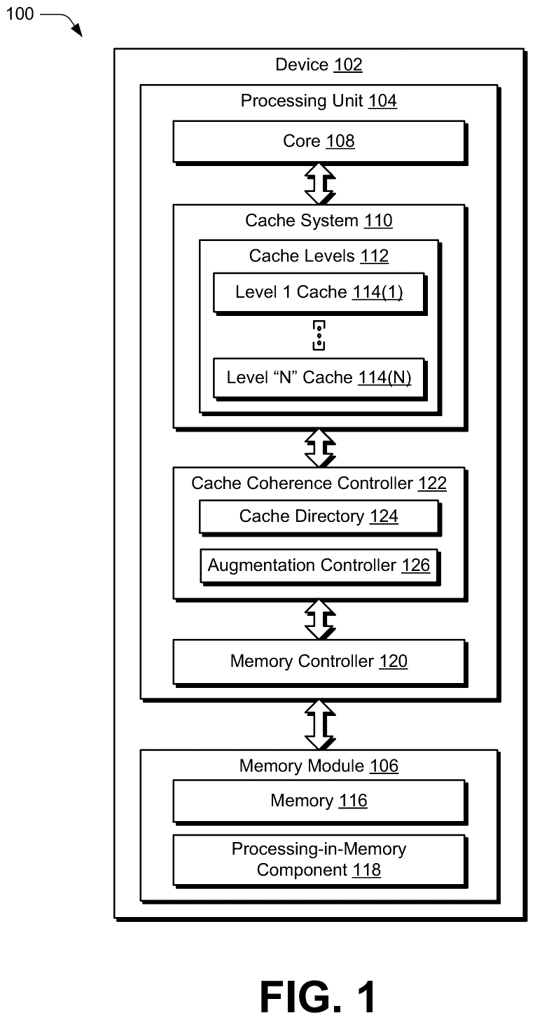

FIG. 1 is a block diagram of a non-limiting example system 100 having a device that implements a processing unit and memory module to implement cache directory lookup address augmentation techniques based on a cache directory lookup. The device 102 includes a processing unit 104 and a memory module 106 communicatively coupled via a bus structure.

These techniques are usable by a wide range of device 102 configurations. Examples of those devices include, by way of example and not limitation, computing devices, servers, mobile devices (e.g., wearables, mobile phones, tablets, laptops), processors (e.g., graphics processing units, central processing units, and accelerators), digital signal processors, machine learning inference accelerators, disk array controllers, hard disk drive host adapters, memory cards, solid-state drives, wireless communications hardware connections, Ethernet hardware connections, switches, bridges, network interface controllers, and other apparatus configurations. Additional examples include artificial intelligence training accelerators, cryptography and compression accelerators, network packet processors, and video coders and decoders.

The processing unit 104 includes a core 108. The core 108 is an electronic circuit (e.g., implemented as an integrated circuit) that performs various operations on and/or using data in the memory module 106. Examples of processing unit 104 and core 108 configurations include, but are not limited to, a central processing unit (CPU), a graphics processing unit (GPU), a field programmable gate array (FPGA), an accelerated processing unit (APU), and a digital signal processor (DSP). For example, the core 108 is a processing unit that reads and executes instructions (e.g., of a program), examples of which include to add, to move data, and to branch. Although one core 108 is depicted in the illustrated example, in variations, the device 102 includes more than one core 108, e.g., the device 102 is a multi-core processor. The memory module 106 is implemented as a printed circuit board, on which, memory 116 (e.g., physical memory) and a processing-in-memory component 118 are disposed, e.g., physically and communicatively coupled using one or more sockets.

The processing unit 104 includes a cache system 110 having a plurality of cache levels 112, examples of which are illustrated as a level 1 cache 114(1) through a level “N” cache 114(N). The cache system 110 is configured in hardware (e.g., as an integrated circuit) communicatively disposed between the processing unit 104 and the memory 116 of the memory module 106. The cache system 110 is configurable as integral with the core 108 as part of the processing unit 104, as a dedicated hardware device as part of the processing unit 104, and so forth. Configuration of the cache levels 112 as hardware is utilized to take advantage of a variety of locality factors. Spatial locality is used to improve operation in situations in which data is requested that is stored physically close to data that is a subject of a previous request. Temporal locality is used to address scenarios in which data that has already been requested will be requested again.

In cache operations, a “hit” occurs to a cache level when data that is subject of a load operation is available via the cache level, and a “miss” occurs when the desired data is not available via the cache level. When employing multiple cache levels, requests proceed through successive cache levels 112 until the data is located. The cache system 110 is configurable in a variety of ways (e.g., in hardware) to address a variety of processor unit 104 configurations, such as a central processing unit cache, graphics processing unit cache, parallel processor unit cache, digital signal processor cache, and so forth.

In one or more implementations, the memory module 106 is a circuit board (e.g., a printed circuit board), on which memory 116 (i.e., physical memory such as dynamic random access memory) is mounted and includes a processing-in-memory component 118, e.g., implemented in hardware using one or more integrated circuits. In some variations, one or more integrated circuits of the memory 116 are mounted on the circuit board of the memory module 106, and the memory module 106 includes one or more processing-in-memory components 118. Examples of the memory module 106 include, but are not limited to, a TransFlash memory module, a single in-line memory module (SIMM), and a dual in-line memory module (DIMM). In one or more implementations, the memory module 106 is a single integrated circuit device that incorporates the memory 116 and the processing-in-memory component 118 on a single chip. In some examples, the memory module 106 is formed using multiple chips that implement the memory 116 and the processing-in-memory component 118 that are vertically (“3D”) stacked together, are placed side-by-side on an interposer or substrate or are assembled via a combination of vertical stacking or side-by-side placement.

The memory 116 is a device or system that is used to store data, such as for immediate use in a device, e.g., by the core 108 and/or by the processing-in-memory component 118. In one or more implementations, the memory 116 corresponds to semiconductor memory where data is stored within memory cells on one or more integrated circuits. In at least one example, the memory 116 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 116 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM).

The processing-in-memory component 118 is implemented in hardware (e.g., as an integrated circuit) configured to perform operations responsive to processing-in-memory instructions, e.g., received from the core 108. The processing-in-memory component 118 is representative of a processor with example processing capabilities ranging from relatively simple (e.g., an adding machine) to relatively complex (e.g., a CPU/GPU compute core). In an example, the processing-in-memory component 118 processes the instructions using data stored in the memory 116.

Processing-in-memory contrasts with standard computer architectures which obtain data from memory, communicate the data to a remote processing unit (e.g., the core 108), and process the data using the remote processing unit, e.g., using the core 108 rather than the processing-in-memory component 118. In various scenarios, the data produced by the remote processing unit as a result of processing the obtained data is written back to memory, which involves communicating the produced data from the remote processing unit to memory.

In terms of data communication pathways, the remote processing unit (e.g., the core 108) is further away from the memory 116 than the processing-in-memory component 118. As a result, these standard computer architectures suffer from increased data transfer latency, reduced data communication bandwidth, and increased data communication energy, particularly when the volume of data transferred between the memory and the remote processing unit is large, which can also decrease overall computer performance. Thus, the processing-in-memory component 118 enables increased computer performance while reducing data transfer energy as compared to standard computer architectures that implement remote processing hardware. Further, the processing-in-memory component 118 alleviates memory performance and energy bottlenecks by moving one or more memory-intensive computations closer to the memory 116.

Although the processing-in-memory component 118 is illustrated as being disposed within the memory module 106 (e.g., within a same integrated circuit or on a same printed circuit board), other examples are also contemplated. The processing-in-memory component 118, for instance, is also configurable to incorporate processing capability near memory modules so that tasks are also processed without costly round-trip transmission to host processors or other distant computing units. Access to the memory module 106 for the processing unit 104 is controlled through use of a memory controller 120.

The memory controller 120 is a digital circuit (e.g., implemented in hardware) that manages the flow of data to and from the memory 116 of the memory module 106. By way of example, the memory controller 120 includes logic to read and write to the memory 116. In one or more implementations, the memory controller 120 also includes logic to read and write to registers (e.g., temporary data storage) maintained by the processing-in-memory component 118, and to interface with the processing-in-memory component 118, e.g., to provide instructions for processing by the processing-in-memory component 118.

The memory controller 120 also interfaces with the core 108. For instance, the memory controller 120 receives instructions from the core 108, via the cache coherence controller 122. The instructions involve accessing the memory 116 and/or the registers of the processing-in-memory component 118 and provide data to the core 108, e.g., for processing by the core 108. In one or more implementations, the memory controller 120 is communicatively located between the core 108 and the memory module 106, and the memory controller 120 interfaces with the core 108, the memory module 106, and the cache coherence controller 122.

The core 108 is configured to initiate processing-in-memory (PIM) operations by the processing-in-memory component 118 using processing-in-memory instructions. To ensure that the processing-in-memory component 118 operations on a valid version of data in the memory 116, a cache coherence controller 122 is employed. The cache coherency controller 112 is configurable in hardware (e.g., as one or more integrated circuits), support execution of instructions (e.g., by a microcontroller), and so forth. Validity of the data in the memory 116 refers to a scenario in which a version of data that is to be subject of a processing-in-memory operation is valid (e.g., is accurate in that the data has not been subsequently processed elsewhere) in the processing-in-memory component and the cache system 110. The cache coherence controller 122 is configured to query a cache directory 124 in what is referred to as a “cache directory lookup.” The cache directory 124 describes which memory addresses of the memory 116 are maintained in the cache system 110 and a status of data at those memory addresses. A cache directory lookup, for instance, is used to determine whether the data at the memory address is “clean” and unchanged with respect to the data for that memory address maintained in the memory 116 or “dirty” and is changed. Therefore, a cache directory lookup as performed by the cache coherence controller 122 is usable to determine “what” data is stored in the cache system 110 and a status of that data.

This is performable by the cache coherence controller 122 as a flush in a “dirty” scenario in which the data is caused to be “flushed” from the cache system 110 for storage in the memory 116, which then makes the data stored in the memory 116 valid for a processing-in-memory operation by the processing-in-memory component 118. In a “clean” scenario, the cache coherence controller 122 generates a cache request to cause the cache system 110 to invalidate the clean data in the cache system 110 such that subsequent accesses to the memory address are performed using the memory 116 and not the cache system 110 and as such is also valid for use as part of a processing-in-memory operation in that the accesses are performed to the memory 116 and not the cache system 110. In this way, subsequent memory requests (e.g., as part of corresponding PIM operations) retrieve the data from memory 116 (e.g., that has been processed as part of the PIM operation) instead of using stale data from the cache system 110.

The cache coherence controller 122 leverages configuration of processing-in-memory instructions in this example to improve operational efficiency as part of cache directory lookups. A single processing-in-memory instruction, for instance, is configurable to cause execution of a same operation at a row and column specified in a memory request for each of a plurality of memory banks in memory. To reduce an overhead of opening new rows in memory, processing-in-memory instructions are configurable to leverage spatial locality and issue a subsequent memory request to the same rows. Consequently, if a processing-in-memory instruction specifies a particular row and column in a memory bank of the memory 116, a subsequent processing-in-memory instruction is likely to specify access to other columns in the same row of activations for the memory 116.

The cache coherence controller 122 uses this insight as part of cache directory lookups, functionality of which is represented by an augmentation controller 126. The augmentation controller 126 is configured (e.g., in hardware, software, or a combination thereof) to augment a probe filter request generated by the cache coherence controller 122 with an additional memory address. The augmentation controller 126, for instance, is implemented in hardware using one or more integrated circuits. In another instance, the augmentation controller 126 is implemented to execute instructions, e.g., as a microcontroller. The augmentation controller 126, for instance, is configurable to leverage memory request patterns exhibited as part of processing-in-memory operations by speculatively performing cache directory lookups for an additional memory address, e.g., that is not included in the memory request.

The augmentation controller 126 is configurable to identify the additional memory address based on a memory address included in the memory request from the core 108. This is performed with the expectation that a subsequent memory request from the core 108 will likely arrive for that additional memory address, e.g., based on temporal locality and/or spatial locality. As a result, a subsequent memory request (e.g., and associated PIM operations) for that additional memory address is not stalled, e.g., by waiting for the cache system 110 to return evicted data to memory 116 and/or to acknowledge invalidation of the data in the cache system. In this way, the techniques described herein improve operational efficiency of the processing-in-memory component 118 to operate on valid data, reduce latency, reduce power consumption, and reduce bottlenecks caused by conventional techniques that stalled as a result of the cache directory lookup.

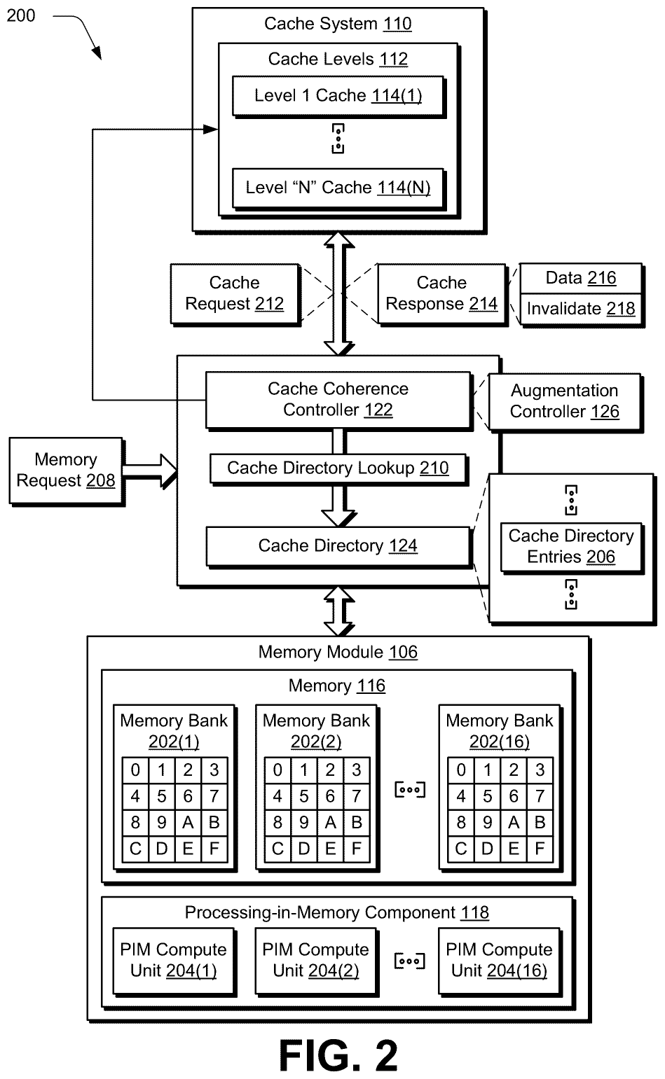

FIG. 2 is a block diagram of a non-limiting example system 200 showing operation of a cache coherence controller of FIG. 1 in greater detail as performing a cache directory lookup and generation of a cache request based on the cache directory lookup. In this example, the memory 116 is implemented using a plurality of memory banks, examples of which are illustrated as memory bank 202(1), memory bank 202(2), . . . , memory bank 202(16). Likewise, the processing-in-memory component 118 is illustrated as including respective processing-in-memory (PIM) compute units, examples of which are illustrated as PIM compute unit 204(1), PIM compute unit 204(2), . . . , PIM compute unit 204(16).

The PIM compute units 204(1)-204(16) are configurable with a variety of processing capabilities in hardware (e.g., using one or more integrated circuits) ranging from relatively simple (e.g., an adding machine) to relatively complex, e.g., a CPU/GPU compute core. The processing unit 104 is configured to offload memory bound computations to the one or more in-memory processors of the processing-in-memory component 118. To do so, the core 108 generates PIM instructions and transmits the PIM instructions, via the memory controller 120, to the memory module 106. The processing-in-memory component 118 receives the PIM instructions and processes the instructions as PIM operations using the PIM compute units 204(1)-204(16) and data stored in the memory 116.

Processing-in-memory using PIM compute units 204(1)-204(16) contrasts with standard computer architectures which obtain data from memory 116, communicate the data to the core 108 of the processing unit 104, and process the data using the core 108 rather than the processing-in-memory component 118. In various scenarios, the data produced by the core 108 as a result of processing the obtained data is written back to the memory 116, which involves communicating the produced data over the pathway from the core 108 to the memory 116. In terms of data communication pathways, the core 108 is further away from the memory 116 than the processing-in-memory component 118. As a result, conventional computer architectures suffer from increased data transfer latency, reduced data communication bandwidth, and increased data communication energy, particularly when the volume of data transferred between the memory 116 and the processing unit 104 is large, which can also decrease overall device 102 performance.

In one or more implementations, the core 108 retrieves data from the memory 116 and stores the data in one or more caches levels 112 of a cache system 110 associated with the core 108. By way of example, the cache levels 112 of the core 108 include a level 1 cache 114(1), . . . , through a level “N” cache 114(N). In implementations in which the core 108 is a multi-core processor, for instance, the cache levels 112 include a level 3 cache is shared by each of the multiple cores 108. Thus, in these implementations, each core 108 of the multi-core processor stores data in a level 1 cache, a level 2 cache, and a shared level 3 cache. In terms of data communication pathways, the cache levels 112 are closer to the core 108 than the memory 116, and as such, data stored in the cache system 110 is accessible in less amount of time by the core 108 than an amount of time taken to access the data stored in the memory 116. It is to be appreciated that the one or more cores 108 of the processing unit 104 are configurable to include cache subsystems with differing numbers of caches and different hierarchical structures without departing from the spirit or scope of the described techniques.

In various examples, the core 108 retrieves a cache line in response to receiving an instruction to access a particular memory address. As used herein, a “cache line” is a unit of data transfer between the memory 116 and the cache system 110. In one example, the cache line is four bytes and the core 108 retrieves a contiguous four-byte block of data from the memory 116 that includes the data of the particular memory address. Further, the core 108 stores the four-byte block of data as a cache line in the cache system 110. If the core 108 receives a subsequent instruction to access a memory address that is a part of the cache line, the core 108 accesses the data of the memory address from the cache system 110, rather than the memory 116.

In one or more examples, the cache system 110 and the memory 116 store different versions of a corresponding cache line. For instance, the core 108 modifies a cache line that is stored in a cache level 112 of the cache system 110, and as such, the data corresponding to the cache line that is stored in the memory 116 is stale and therefore not valid for operations. Accordingly, the cache coherence controller 122 is employed to enforce cache coherence among the cache system 110 and the memory 116. Notably, cache coherence is the uniformity of data that is storable in multiple different memory resources in a system, e.g., the cache system 110 and the memory 116. As part of enforcing cache coherence, the cache coherence controller 122 employs a cache directory 124, which includes cache directory entries 206 for cache lines that are stored in one or more of the cache levels 112 of the cache system 110. In response to cache lines being added to the cache system 110, the cache coherence controller 122 creates cache directory entries 206 in the cache directory 124 that includes a range of memory addresses corresponding to the cache line.

In one example, the cache coherence controller 122 receives a memory request 208 to access data of a memory address from the memory 116. In response, the cache coherence controller 122 performs a cache directory lookup 210 in the cache directory 124. The cache directory lookup 210 is used to determine whether one of the cache directory entries 206 represents a cache line that includes the memory address referenced by the memory request 208.

Based on a result of the cache directory lookup 210, the cache coherence controller 122 performs a corresponding coherence protocol. By way of example, a cache directory 124 miss occurs when the cache directory entries do not include the memory address (e.g., address range) specified by the memory request 208, and therefore the data as maintained for that memory address is valid in memory 116. In contrast, a cache directory 124 hit occurs when there is a cache directory entry 206 included in the cache directory 124 having an address range that includes the memory address of the memory request 208, and therefore the data as maintained for that memory address is not valid in memory 116.

Thus, the determination of whether a hit “has” or “has not” occurred serves as a basis to determine whether data in the memory specified by the memory request 208 is valid, e.g., for execution of a PIM operation by a respective processing-in-memory component 118. As previously described above, scenarios in which the data is not valid involve additional latency, either to cause the data to be flushed from the cache system 110 to the memory 116 or set to invalidate the data in the cache system 110. This challenge is increased when confronted with parallel execution scenarios.

As illustrated in FIG. 2, the memory 116 includes a plurality of memory banks 202(1)-202(16) that are organized into one or more memory arrays (e.g., grids), which include rows and columns such that data is stored in individual cells of the memory arrays. The memory banks 202(1)-202(16) are representative of a grouping of banks in relation to which the processing-in-memory component 118 is configured to perform various in-memory processing operations. By way of example, PIM compute units 204(1)-204(16) of the processing-in-memory component 118 are included as part of a memory channel along with respective ones of the memory banks 202(1)-202(16). The processing-in-memory component 118, through use of the PIM compute units 204(1)-204(16), performs in-memory processing operations on the data that is stored in the memory banks 202(1)-202(16). In the illustrated example, a plurality of memory channels includes a respective one of the PIM compute units 204(1)-204(16) and a respective one of the memory banks 202(1)-202(16), and a cache coherence controller 122 to enforce cache coherence among the memory banks 202(1)-202(16) within the memory channel and the cache levels 112 of the cache system 110.

The processing-in-memory component 118 is configurable to operate on each of the memory banks 202(1)-202(16) in parallel to execute a single PIM instruction. In the illustrated example, the processing-in-memory component 118 is configured to operate on sixteen memory banks 202(1)-202(16) and receives a PIM instruction to read data from a particular row and column address. To execute the instruction, the processing-in-memory component 118 reads the data of the particular row and column address from each of the memory banks 202(1)-202(16) in parallel.

Therefore, a single PIM instruction of a conventionally configured system triggers a plurality of cache directory lookups 210 in the cache directory 124, e.g., one lookup for memory addresses in each one of the multiple memory banks 202(1)-202(16). This is performed to ensure that the requested data stored in each of the memory banks 202(1)-202(16) is “valid” as being coherent with other instances of the requested data stored in the cache system 110.

Continuing with the previous example in which the processing-in-memory component 118 is configured to operate on sixteen memory banks 202(1)-202(16), a standard cache coherence controller 122 performs sixteen cache directory 124 cache directory lookups 210 for a single PIM instruction. A cache directory lookup 210, however, is a computationally expensive task, particularly when a significant number (e.g., sixteen) of cache directory lookups are performed sequentially. Moreover, this significant number of cache directory lookups when performed even for a single PIM instruction often create a bottleneck in the cache directory 124 that affects both PIM workloads and non-PIM workloads. These problems are exacerbated by the notion that PIM instructions are often issued together as a series of sequential PIM instructions, rather than interspersed with non-PIM instructions. Due to this, the number of cache directory lookups to be performed multiplies with each sequential PIM instruction, thereby worsening the bottleneck and increasing cache directory lookup 210 latency and latency of operations that depend on these lookups, e.g., for processing by the processing-in-memory component 118.

To overcome these drawbacks of conventional techniques, an augmentation controller 126 is employed to augment cache directory lookups. The augmentation controller 126 is configured to leverage insight that a series of memory requests are likely to involve neighboring memory addresses in the memory 116. Accordingly, a cache directory lookup 210 is performed for a memory address in a memory request 208 is augmented to include an additional memory address, e.g., a neighboring memory address. As a result, the cache coherence controller is configured to take steps toward validating both the memory address as specified in the memory request as well as for the additional memory address. Therefore, a subsequent memory request involving the additional memory address is already valid for execution of a respective processing-in-memory operation, thereby reducing latency resulting from a round trip communication with the cache system 110 in order to validate this data.

If the cache directory lookup 210 indicates that data specified for a memory address in the memory request 208 is not valid for execution of a processing-in-memory instruction, the cache coherence controller 122 transmits a cache request 212 to the cache system 110. This causes the cache system 110 to transmit a cache response 214 such that the data in the memory 116 is subsequently valid for computation by the processing-in-memory component. This is performable, for instance, by leveraging the cache request to cause the cache system to write the data 216 back to memory (e.g., “flush” the data) and/or invalidate 218 the data in the cache system 110, which is acknowledged by the cache response 214. The cache coherence controller 122 then releases the memory request 208 to the processing-in-memory component 118 for processing, e.g., via a memory controller 120 for performance as part of a processing-in-memory operation.

The cache request is configurable to leverage a result of the cache directory lookup 210. In a first example, the cache directory lookup 210 indicates that the data for the memory address specified in the memory request 208 is not valid and also that the data for the additional memory address used to augment the cache directory lookup 210 is also not valid. In response, the cache request 212 is generated to specify both memory addresses, such that the cache response 214 is usable to cause validation of data at both the memory address and the additional memory address. This is also performable in an either/or scenario, e.g., to specify the memory address or the additional memory address in the cache request 212 for each address that is determined as not being valid as further described in relation to the following examples.

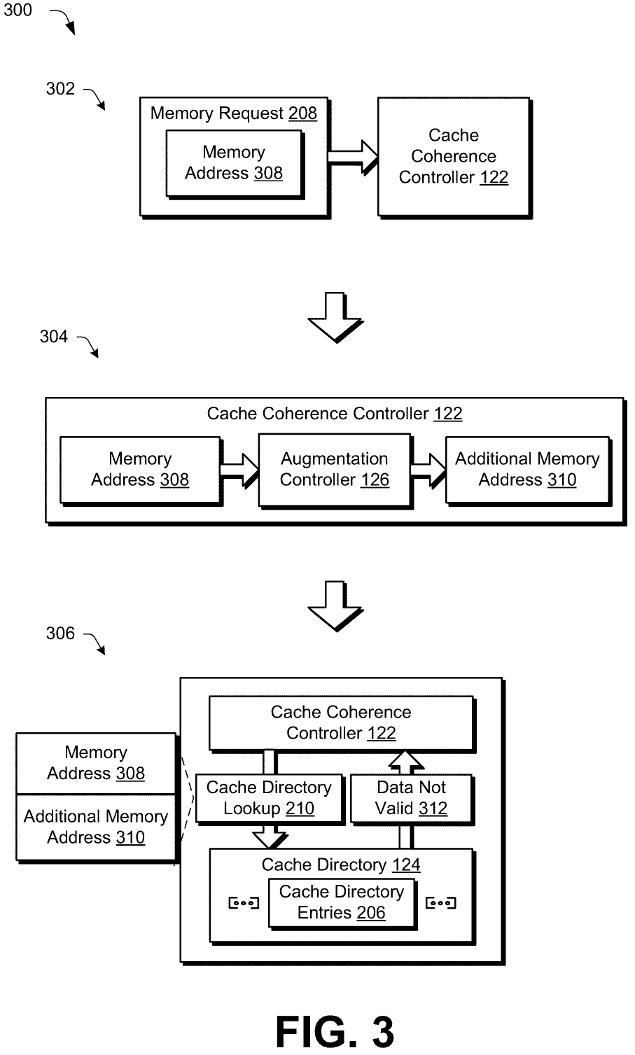

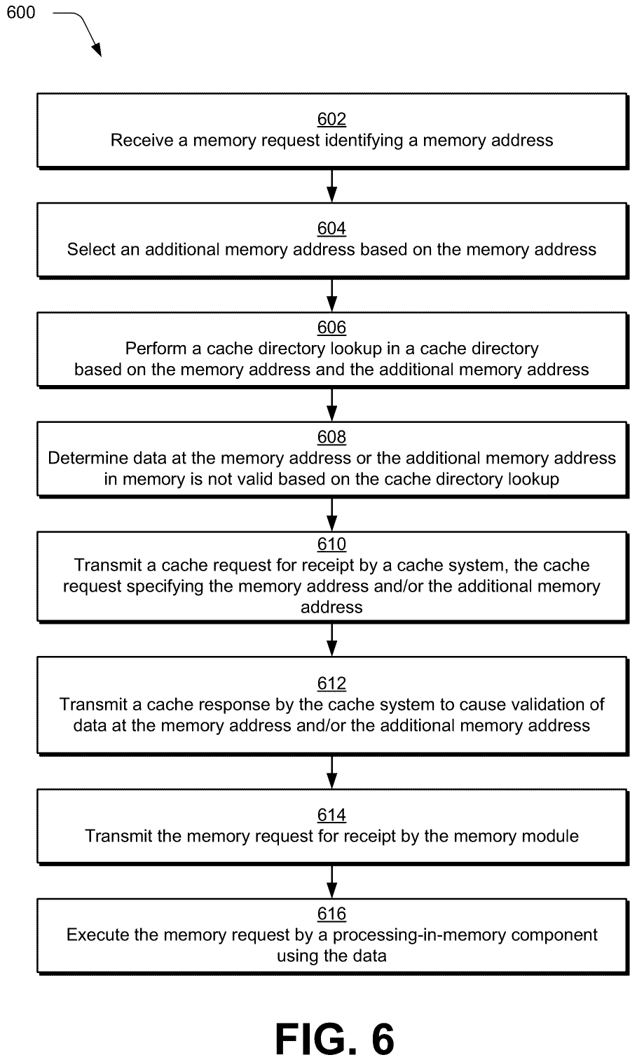

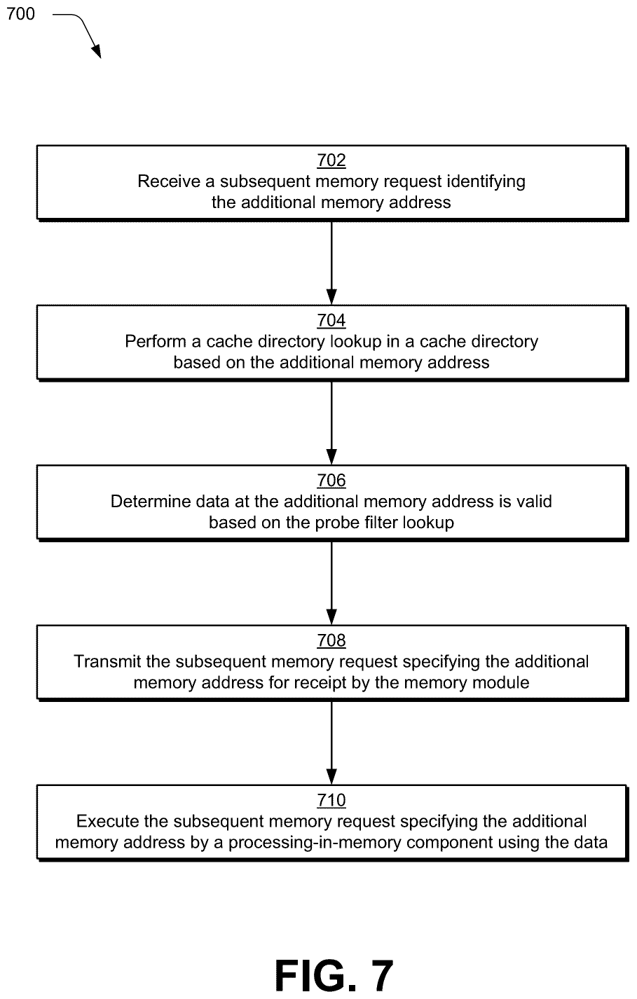

In the following discussion, operation of example systems of FIGS. 3-6 is described in parallel to procedures FIGS. 6 and 7. FIG. 6 a block diagram of a non-limiting example procedure 600 of a step-wise algorithm that provides structure for describing performance of an augmented cache directory lookup. FIG. 7 a block diagram of a non-limiting example procedure 700 a step-wise algorithm that provides structure for describing performance of a cache directory lookup for an augmented additional memory address of FIG. 6.

FIG. 3 is a block diagram of a non-limiting example system 300 illustrated using first, second, and third stages 302, 304, 306 as showing receipt of a memory request specifying a memory address, generation of an additional memory address based on the memory address, and performance of a cache directory lookup using the memory address and the additional memory.

At a first stage 302 of FIG. 3, a memory request 208 is received at a cache coherence controller 122 that identifies a memory address 308 (block 602). The memory request 208, for instance, originates through software execution (e.g., an application, operating system) at the core 108 and is received at the cache coherence controller 122 via a communicative coupling, e.g., a bus structure.

At a second stage 304 of FIG. 3, an additional memory address 310 is selected based on memory address 308 (block 604) by the cache coherence controller 122. In an example, the augmentation controller 126 generates the additional memory address 310 based on the memory address 308. Spatial locality is used in one example to select the additional memory address 310 as being stored physically close to the memory address 308. Temporal locality is used in another example to address scenarios in which an additional memory address 310 which was already requested and a likelihood that the additional memory address 310 will be requested again, e.g., as associated with the memory address 308.

At a third stage 306 of FIG. 3, a cache directory lookup is performed in a cache directory 124 by a cache coherence controller 122 based on the memory address 308 and the additional memory address 310 (block 606). The cache directory lookup 210 is based on the memory address 308 included in the memory request 208. The cache directory lookup 210 queries the cache directory entries 206 to determine whether the memory address 308 is included within cache lines described by the cache directory entries 206.

The cache directory lookup 210 is also performed for the additional memory address 310. As a result, the additional memory address 310 augments the cache directory lookup 210 operation to be performed for both the memory address 308 in the memory request 208 as well as at least one additional memory address 310 not included in the memory request 208 (block 608).

In the illustrated example, a determination is made by the cache coherence controller 122 that data at the memory address 308 and/or the additional memory address 310 is not valid based on the cache directory lookup, e.g., returned as a data not valid 312 indication from a query to the cache directory 124. This validation is performable, for instance, based on whether a “hit” is obtained to the cache directory 124 based on the memory address 308 and/or the additional memory address 310. If so, this indicates that a version of the data maintained in the memory 116 is also maintained in the cache system 110. Therefore, the cache coherence controller 122 is configured to perform operations such that the data in the memory 116 is made valid for the memory request 208, e.g., as a basis by the processing-in-memory component 118 to perform a PIM operation using the data.

In another example, the data at the memory address 308 and/or the additional memory address 310 is valid. In response, the cache directory entries 206 corresponding to the memory address 308 and/or the additional memory address 310 are set such that subsequent access is made directly to the memory 116 and not to the cache levels 112 of the cache system 110.

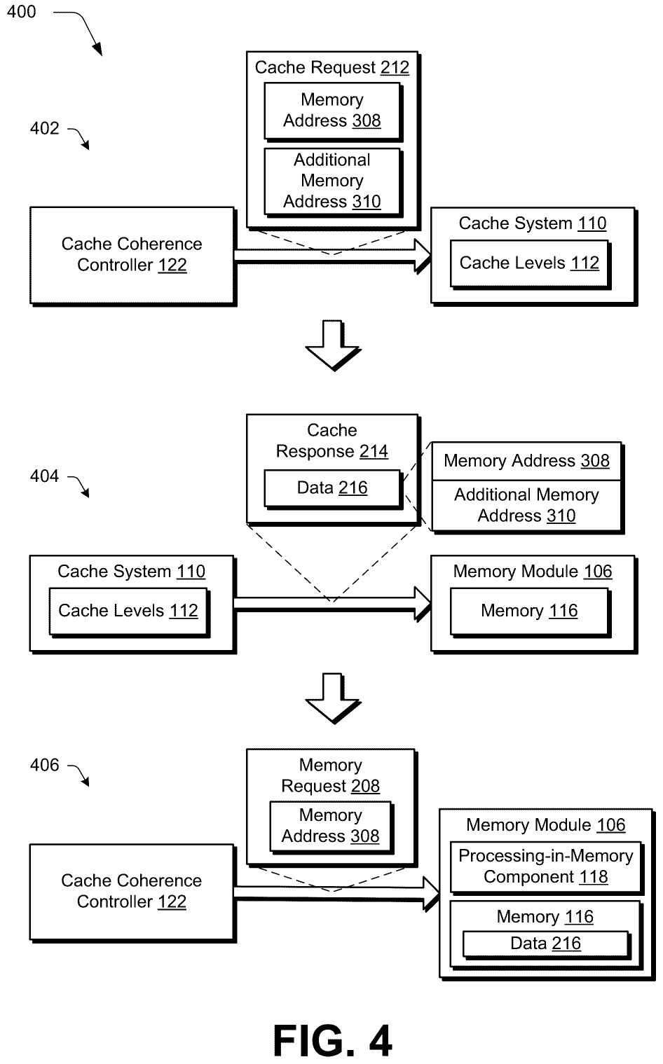

FIG. 4 is a block diagram of a non-limiting example system 400 illustrated using first, second, and third stages 402, 404, 406 as showing validation of data in the memory through use of a cache request and a cache response and forwarding of a memory request to initiate performance of a processing-in-memory operation.

At a first stage 402, a cache request 212 is transmitted for receipt by a cache system 110 by a cache coherence controller 122. The cache request 212 specifies the memory address 308 and/or the additional memory address 310 (block 610). Continuing with the previous example, performance of the cache directory lookup 210 is configured to determine a “hit” by the cache coherence controller 122 to the cache directory 124 for the memory address 308 as well as the additional memory address 310. Therefore, the cache request 212 is configured to identify memory addresses that resulted in a hit to the cache directory 124 and thus are not valid, e.g., the memory address 308 and/or the additional memory address 310. Accordingly, the cache request 212 is generated to cause this data, if not currently valid, to be made valid in the memory 116, e.g., for inclusion as part of a PIM operation performed by the processing-in-memory component 118.

To do so at the second stage 404, a cache system 110 transmits a cache response 214 to cause validation of data at the memory address and/or the additional memory address (block 612). In an instance in which data associated with the memory address 308 and/or the additional memory address 310 is “dirty,” the cache response 214 includes the data for the memory address 308 and/or the additional memory address 310 to be “flushed” to the memory module 106. In an instance in which data associated with the memory address 308 and/or the additional memory address 310 is “clean,” the cache response 214 includes an acknowledgement that the data for the memory address 308 and/or the additional memory address 310 is invalidated. As a result, the cache response 214 causes the data in the memory module 106 to be made valid for both the memory address 308 and the additional memory address 310.

Accordingly, at a third stage 406 the memory request 208 specifying the memory address 308 is transmitted by the cache coherence controller 122 for receipt by the memory module 106 (block 614). The processing-in-memory component 118 is then utilized to execute the memory request 208 (e.g., as part of a PIM operation) using the data 216 (block 616). In this way, the PIM operation proceeds to execute while causing validation of data at the additional memory address 310 for a subsequent PIM operation, as example of which is described in the following discussion.

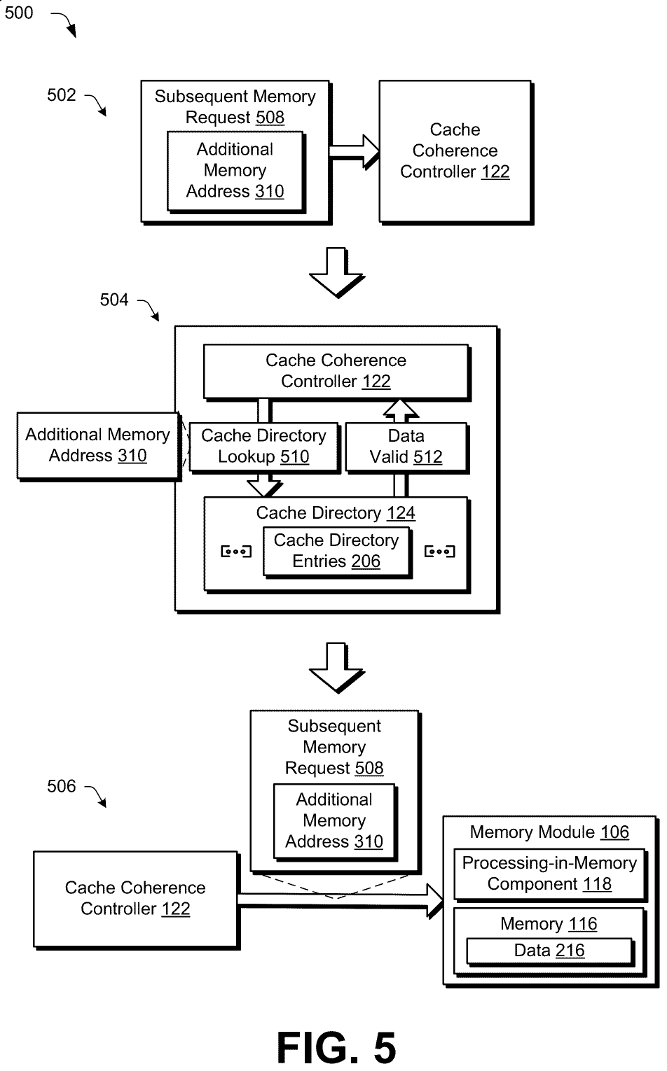

FIG. 5 is a block diagram of a non-limiting example system 500 illustrated using first, second, and third stages 502, 504, 506 as showing receipt of a subsequent memory request specifying an additional memory address, performance of a cache directory lookup using the additional memory address, and transmitting the subsequent memory request based on a determination that the additional memory address is valid in the memory.

At a first stage 502, a subsequent memory request 508 is received by the cache coherence controller 122 that identifies the additional memory address 310 (block 702). The subsequent memory request 508, for instance, is a PIM instruction included as part of a series of PIM instructions generated through execution of software by a core 108 of a processing unit 104 that is configured to minimize row activations and switching rows.

At a second stage 504, a cache directory lookup 510 is performed by a cache coherence controller 122 in a cache directory 124 based on the additional memory address 310 (block 704). As a result of the cache directory lookup 510, a determination is made by the cache coherence controller 122 that data is valid 512 at the additional memory address 310 based on the cache directory lookup (block 706). In other words, the indication that data is valid 512 results from a “miss” to the cache directory 124 for the cache directory lookup 510 for the additional memory address 310. Continuing with the previous example, this is because the data is made valid in the techniques described in relation to FIGS. 3 and 4 for that additional memory address 310. As such, a “round trip” is not performed in this example to cause the data to be valid for the additional memory address 310, thereby improving operational efficiency, reducing power consumption, and so forth.

Accordingly, at a third stage 506 the subsequent memory request 508 that specifies the additional memory address 310 is transmitted by the cache coherence controller 122 for receipt by the memory module 106 (block 708). The processing-in-memory component 118 is then utilized to execute the subsequent memory request 508 (e.g., as part of a PIM operation) using the data 216 for the additional memory address 310 (block 710). In this way, the subsequent PIM operation is performed with increased efficiency and reduced power consumption compared to when a cache directory lookup is involved.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102 having the core 108 and the memory module 106 having the memory 116 and the processing-in-memory component 118) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A system comprising:
a cache system including a plurality of cache levels; and
a cache coherence controller configured to perform a cache directory lookup using a cache directory, the cache directory lookup:
configured to indicate whether data associated with a memory address specified by a memory request is valid in memory; and
augmented to include an additional memory address based on the memory address.

2. The system of claim 1, wherein the cache directory lookup is configured to indicate whether the data associated with the memory address specified by the memory request is valid in memory for use as part of a processing-in-memory operation by a processing-in-memory component.

3. The system of claim 1, wherein the cache directory lookup is configured to indicate whether data associated with the additional memory address is valid in memory for use as part of a processing-in-memory operation by a processing-in-memory component.

4. The system of claim 1, wherein the cache directory includes a plurality of cache directory entries that indicate memory addresses are maintained in the cache system.

5. The system of claim 4, wherein the plurality of cache directory entries specify, respectively, a location of respective memory addresses in the plurality of cache levels in the cache system and a status of the respective memory addresses.

6. The system of claim 1, wherein the cache coherence controller is configured to transmit a cache request to the cache system based on the cache directory lookup indicating the data associated with the memory address specified by the memory request is not valid in the memory for use as part of a processing-in-memory operation by a processing-in-memory component.

7. The system of claim 6, wherein the cache request is configured to cause the cache system to invalidate the data associated with the memory address in the cache system.

8. The system of claim 6, wherein the cache request is configured to cause the cache system to transmit a cache response to the memory, the cache response configured to cause data stored at the memory address in the memory to be valid for use as part of the processing-in-memory operation by the processing-in-memory component.

9. The system of claim 8, wherein the cache response is further configured to cause data stored at the additional memory address in the memory to be valid.

10. The system of claim 1, wherein the cache coherence controller is configured to transmit a cache request to the cache system based on the cache directory lookup indicating the data associated with the additional memory address specified by the memory request is not valid.

11. The system of claim 1, wherein the cache coherence controller is further configured to transmit the memory request for receipt by the memory subsequent to receipt of a cache response from the cache system.

12. The system of claim 11, wherein the memory request is configured to cause a processing-in-memory component of the memory to process data stored at the memory address in the memory.

13. The system of claim 1, wherein the cache coherence controller is configured to select the additional memory address based on spatial locality.

14. The system of claim 1, wherein the memory request is received from a core of a processing unit.

15. A device comprising:
a cache system including a plurality of cache levels;
a memory module having a memory and a processing-in-memory component; and
a cache coherence controller configured to transmit a cache request to the cache system based on a cache directory lookup performed in response to a memory request, the cache request configured to cause the cache system to transmit a cache response to the memory module, the cache response including data from the cache system for a memory address of the memory request and augmented by data from an additional memory address selected by the cache coherence controller as part of the cache directory lookup.

16. The device of claim 15, wherein the cache directory lookup is performed using a cache directory having a plurality of cache directory entries that define which memory addresses are maintained in the cache system.

17. The device of claim 15, wherein the cache response is configured to cause data stored at the memory address and the additional memory address in the memory to be valid.

18. The device of claim 17, wherein the memory request is configured to cause the processing-in-memory component to process the data stored at the memory address in the memory.

19. A method comprising:
performing a cache directory lookup in a cache directory of a cache coherence controller to indicate:
whether data at a memory address specified in a memory request as part of a processing-in-memory instruction is valid in memory; and
whether an additional memory address is valid in the memory, the additional memory address selected by the cache coherence controller based on the memory address specified in the processing-in-memory instruction;
transmitting a cache request by the cache coherence controller for receipt by a cache system, the cache request configured to cause the cache system to transmit a cache response to cause the data at the memory address or the additional memory address in the memory to be valid; and
transmitting the memory request by the cache coherence controller for receipt by a memory module that includes the memory.

20. The method of claim 19, wherein transmitting the memory request by the cache coherence controller for receipt by a memory module that includes the memory is configured to cause execution of the processing-in-memory instruction by a processing-in-memory component.
